(19) United States
(12) Patent Application Publication
(10) Pub. No.: US 2015/0102033 A1
(43) Pub. Date: Apr. 16, 2015

(54) CONTAINER WITH HIGH DENSITY MOLECULAR WEIGHT POLYETHYLENE MOISTURE BARRIER LAYER

(71) Applicant: Silgan Plastics LLC, Chesterfield, MO (US)

(72) Inventor: Susan Banovic, Hoschton, GA (US)

(73) Assignee: Silgan Plastics LLC, Chesterfield, MO (US)

(21) Appl. No.: 14/175,583

(22) Filed: Feb. 7, 2014

Related U.S. Application Data
(60) Provisional application No. 61/889,772, filed on Oct. 11, 2013.

(51) Int. Cl. B65D 1/02; B29C 49/78

(52) U.S. Cl. CPC B65D 1/0215; B65D 1/0246; B29C 49/78
USPC 220/288; 220/62.11; 264/40.1

(57) ABSTRACT

A molded, low moisture vapor transmission plastic container is provided. The container includes a sidewall including an inner surface, an outer surface, a thickness and a first layer formed from a high density polyethylene resin. The container includes a bottom wall located at a lower end of the sidewall, and the bottom wall includes an inner surface and an outer surface. The inner surfaces of the sidewall and of the bottom wall define an interior contents cavity. The container includes a neck located at an upper end of the sidewall defining an opening into the interior contents cavity. The high density polyethylene resin acts as an effective moisture barrier limiting moisture transmission into or out of the container.

### CROSS-REFERENCE TO RELATED PATENT APPLICATION

This application claims the benefit of U.S. Provisional Patent Application No. 61/889,772, filed Oct. 11, 2013, which is incorporated herein by reference in its entirety.

### BACKGROUND OF THE INVENTION

The present invention relates generally to the field of plastic containers. The present invention relates specifically to a plastic container including a moisture barrier layer formed from a high density, polydisperse molecular weight polyethylene.

Molded plastic containers of various types (e.g., blow-molded containers, injection molded containers, extrusion molded containers, etc.) are widely used to hold a wide variety of products including food products, beverages, pharmaceuticals, household chemicals and cleaners, commercial chemicals and cleaners, personal care items, petroleum products, such as oil, gas, etc. The suitability of a particular container design for a particular use depends on a wide variety of design parameters including, for example, strength, crack resistance, dent resistance, molding characteristics, light transmission properties, appearance, texture, hardness, resilience, color, UV resistance, shelf-life, permeability characteristics (e.g., oxygen permeability, water permeability, etc.), resistance to chemical reaction with contents, chemical absorption characteristics, recyclability, etc. Further, performance of a container to meet a set of specific design parameters is a complex function of a number of factors including container size, container shape, molding method, container material, container sterilization procedures, container filling processes, container contents, container and content storage requirements, etc. In addition, many commercial or consumer molded plastic containers are produced using high volume, high-throughput manufacturing processes that have been highly refined for efficiency over many years such that the container produced meets the particular design parameters while being cost minimized.

Once a container design has been proven and accepted by customers, a suitable material identified, and a manufacturing process developed to produce the container in a cost-effective manner, there exist significant economic and other barriers to altering a container design or manufacturing process. For example, identification, testing and implementation of a container design utilizing a new or different plastic material can require significant financial resources and use of human capital to develop a new design. In addition, altering the design also has the potential to risk customer relationships or brand reputation if an altered design does not perform as desired or does not live up to customer expectations. The container producer must make the decision to incur the costs and accept the risks of developing a new container design typically without a guarantee that the design alteration will be successful. These real-world challenges faced by a container producer when a container design is altered tends to direct a container producer to avoid changes in container design (even seemingly minor changes) unless there exists a significant and specifically identified need to make the change that overrides the potential costs and risks of seeking to alter the design. At least in part for this reason, most container producers simply manufacture containers using conventional, well-known designs and conventional and well-known materials.

However, when an innovative container producer or designer identifies a sufficient reason to develop a new container design, developing the new container design typically involves a number of challenges. For example, in many cases, when a container producer seeks to use a different plastic material for a container, the contain producer must first work to identify a subset of candidate materials from potentially thousands of commercially available polymers, and once the subset is identified, rigorous and extensive testing is conducted to further identify whether specific polymer materials are suitable for the intended use. Identification and selection of a suitable polymer resin from the thousands of commercially available materials is typically a significant undertaking that is not attempted without a significant and specifically identified need to utilize a new container material.

### SUMMARY OF THE INVENTION

One embodiment of the invention relates to a molded, low moisture vapor transmission plastic container. The container includes a sidewall having an inner surface, an outer surface, a thickness and a first layer formed from a high density polyethylene resin. The container includes a bottom wall located at a lower end of the sidewall, and the bottom wall includes an inner surface and an outer surface. The inner surfaces of the sidewall and of the bottom wall define an interior contents cavity. The container includes a neck located at an upper end of the sidewall defining an opening into the interior contents cavity. The high density polyethylene resin of the first layer has a resin density of about 0.966 grams/cc and a polydispersity index of about 8.72. The first layer has a USP 31, Chapter 671 moisture vapor transmission rate of 1.145 mg/day-liter or less. In one embodiment, the transmission rate is determined at 75 degrees Fahrenheit at 75 percent relative humidity.

Another embodiment of the invention relates to a low moisture vapor transmission plastic container. The container includes a sidewall including an inner surface, an outer surface and a thickness. The container includes a bottom wall located at a lower end of the sidewall, and the bottom wall includes an inner surface and an outer surface, and the inner surfaces of the sidewall and the bottom wall define an interior contents cavity. The container includes a neck located at an upper end of the sidewall and includes an engagement structure configured to engage a closure to seal the container. At least a portion of the sidewall is formed from a moisture barrier, high density polyethylene resin having a resin density greater than 0.960 and less than 0.970 grams/cc and a polydispersity index between 8 and 10. The sidewall has a thickness between 10 mils and 50 mils. The moisture barrier, high density polyethylene resin has a water vapor transmission rate such that less than 0.050 grams of water per day traverse a layer of the moisture barrier, high density polyethylene resin having thickness of 1 mil and a surface area of 100 in². In one embodiment, the transmission rate is determined at 75 degrees Fahrenheit at 75 percent relative humidity.

Another embodiment of the invention relates to method of forming low moisture vapor transmission plastic containers. The method includes the step of molding a first group of a plurality of containers from a polyethylene resin having a resin density greater than 0.960 and less than 0.970 grams/cc and a polydispersity index between 8.5 and 9.0. The method includes the step of testing the moisture vapor transmission rate of a wall of each container of the first group, wherein the container formed from the polyethylene resin has a water vapor transmission rate such that less than 0.050 grams of water per day traverse a layer of the polyethylene resin having thickness of 1 mil and a surface area of 100 in². The method includes molding a second group of a plurality of containers. Each container of the second group has a layer formed from the polyethylene resin and has a sidewall defining an interior cavity and a neck defining an opening into the interior cavity.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a container according to an exemplary embodiment.

FIG. 2 is a cross-sectional view of a wall of the container of FIG. 1 according to an exemplary embodiment.

FIG. 3 is a cross-sectional view of a wall of the container of FIG. 1 according to another exemplary embodiment.

FIG. 4 is a cross-sectional view of a wall of the container of FIG. 1 according to another exemplary embodiment.

FIG. 5 is a diagram of a method of forming low moisture vapor transmission plastic containers according to an exemplary embodiment.

### DETAILED DESCRIPTION

Referring generally to the figures, various embodiments of a molded plastic container having a moisture barrier polymer layer are shown and described. Specifically, the plastic containers discussed herein include at least one layer formed from a polymer of a specifically selected class or group of polymer materials that have been found to have improved moisture vapor transmission resistance properties compared to many polymer materials typically used for molded plastic containers. Utilizing the polymer materials discussed herein for low moisture vapor transmission plastic containers provides containers that are less susceptible to product spoilage and/or may be formed using a thinner wall material to achieve a satisfactory moisture vapor transmission rate.

In various embodiments, the moisture barrier polymer discussed herein is a high density polyethylene material. In various embodiments, the material is a polydisperse, high-density polyethylene material and may be a polyethylene having a bimodal molecular weight distribution profile. It has been found that the materials discussed herein are suitable to produce low moisture vapor transmission containers via a number of container molding processes including blow molding, injection molding, compression molding and extrusion molding. In addition, it has found that the materials discussed herein have significantly lower moisture vapor transmission rates that many polyethylene materials typically used to make molded containers.

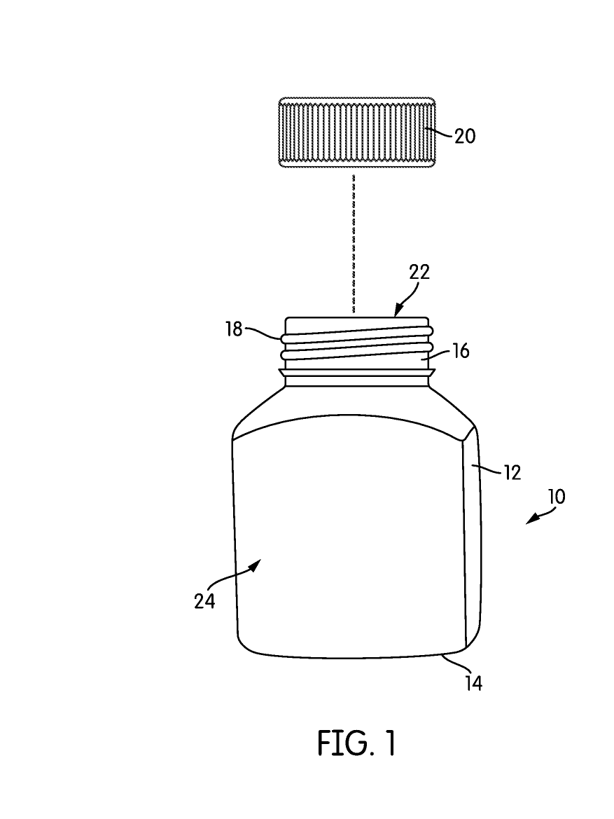

Referring to FIG. 1, a container 10 is shown. Container 10 includes a sidewall 12, a bottom wall 14 and a neck 16. As shown, bottom wall 14 defines the bottom surface of container 10, and sidewall 12 extends from bottom wall 14 to neck 16. Neck 16 includes an engagement structure, shown as threads 18, configured to engage closure, shown as cap 20 to retain cap 20 on neck 16 to seal open end, shown as mouth 22. In one embodiment, threads 18 are configured to engage cooperating threads formed on the inner surface of cap 20. In another embodiment, the engagement structure is a configured to engage a closure, such as a septum configured to seal mouth 22 of neck 16.

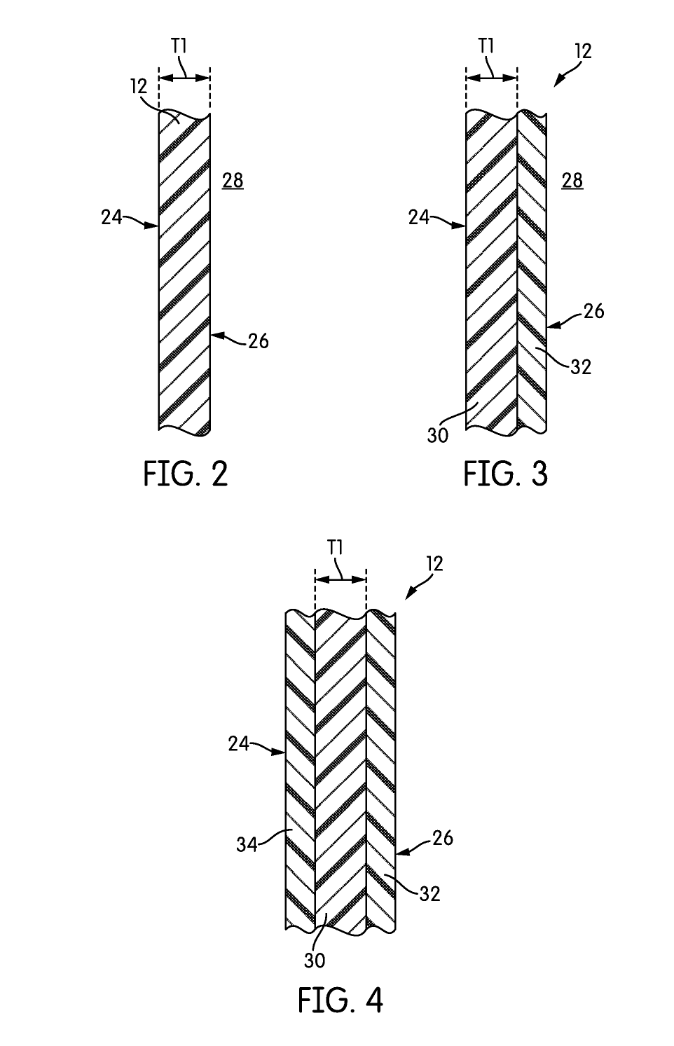

The outer surfaces of sidewall 12, bottom wall 14 and neck 16 generally define outer surface 24 of container 10. As shown in FIG. 2, the inner surfaces of sidewall 12, bottom wall 14 and neck 16 define inner surface 26 of container 10. Inner surface 26 defines an interior cavity 28 located within container 10. A material or product is located within an interior contents cavity, shown cavity 28, following filing of the container. Following filing of container 10, cap 20 is coupled to neck 16 to seal container mouth 22. It should be understood that while, FIGS. 2-4 specifically show a cross-section of a portion of sidewall 12, any wall or portion of container 10, including bottom wall 14 and neck 16, may have a cross-section as discussed and shown relative to FIGS. 2-4.

Container 10 is a molded plastic container formed from a low moisture vapor transmission polymer material as discussed in more detail below. In one embodiment, container 10 is formed by blow-molding. In another embodiment, container 10 is formed by injection blow molding. In another embodiment, container 10 is formed by a stretch blow-molding process and specifically may be formed by either one step or two step blow-molding processes. In yet another embodiment, container 10 is formed from extrusion molding, and in a specific embodiment, container 10 may be an extruded tube type container. In another embodiment, container 10 is an injection molded container. In another embodiment, container 10 is formed by compression molding.

Container 10 may be configured to hold a wide variety of materials. In various embodiments, container 10 holds a dry product, such as tablet or powdered pharmaceuticals. In other embodiments, container 10 is configured to hold liquid products, such as liquid pharmaceuticals, that may be sensitive to moisture gain or loss. In some such embodiments, the moisture barrier properties of sidewall 12 act to limit moisture loss through the walls of container 10. In other embodiments, container 10 may hold a wide variety of products or materials including, but not necessarily limited to, food products, beverages, pharmaceuticals, household chemicals and cleaners, commercial chemicals and cleaners, personal care items, petroleum products, such as oil, gas, etc.

In the embodiment shown in FIG. 2, sidewall 12, bottom wall 14 and neck 16 are formed from a single layer of molded polymer material. In such embodiments, the entire thickness of the walls of container 10 extending between outer surface 24 and inner surface 26 are formed from one of the low moisture vapor transmission materials discussed below.

In various embodiments, container 10 is formed from a moisture barrier, high density polyethylene material that provides a low moisture vapor transmission rate through the walls of container 10. In various embodiments, the high density polyethylene material used to form container 10 has a density (e.g., a resin density or pre-molding density) between 0.960 grams/cc and 0.970 grams/cc. In a specific embodiment, the high density polyethylene used to form container 10 has a density of about 0.966 grams/cc (e.g., plus or minus 0.001 grams/cc). I have found that polyethylene materials having a density that falls within this range provide low moisture vapor transmission characteristics when compared to typical polyethylenes used for containers while still remaining suitable for commercial container production methods (e.g., high volume blow-molding) and still providing properties suitable for a consumer or commercial container (e.g., strength, rigidity, crack resistance, etc.). In various embodiments, the polyethylene material is a high density octene homopolymer polyethylene material.

In various embodiments, container 10 may be molded via a blow-molding process, such as a stretch blow-molding process. In such embodiments, the density of the polyethylene material of container 10 following blow-molding is less than the resin density of the polyethylene material prior to blow molding. In various embodiments, container 10 is formed from a polyethylene material having the resin densities discussed above, and the density of the polyethylene material of container 10 following blow-molding is between 0.940 and 0.955 grams/cc, specifically between 0.945 and 0.950 grams/cc and more specifically between 0.948 and 0.950 grams/cc. In a specific embodiment, the density of the polyethylene material of container 10 following blow-molding is about 0.9488 grams/cc (e.g., plus or minus 0.0001 grams/cc).

In various embodiments, the high density polyethylene material is a material having a molecular weight characteristic within identified ranges that is believed to correlate with a polyethylene having low moisture vapor transmission rates as well as satisfactory manufacturing and container properties. In various embodiments, the high density polyethylene material has a weight-average, molecular weight (Mw) of between 90,000 g/mole and 110,000 g/mole, specifically between 95,000 g/mole and 105,000 g/mole and more specifically between 99,000 g/mole and 102,000 g/mole. In a specific embodiment, the high density polyethylene material has an Mw of 101,072 g/mole. In various embodiments, the high density polyethylene material has a number-average, molecular weight (Mn) of between 11,000 g/mole and 12,000 g/mole and more specifically between 11,250 g/mole and 11,750 g/mole. In a specific embodiment, the high density polyethylene material has an Mn of 11,595 g/mole. In various embodiments, the high density polyethylene material has a Z-average molecular weight (Mz) of between 250,000 g/mole and 550,000 g/mole, specifically between 350,000 g/mole and 450,000 g/mole, and more specifically between 325,000 g/mole and 375,000 g/mole. In a specific embodiment, the high density polyethylene material has an Mz of 353,889 g/mole.

In various embodiments, the high density polyethylene material has a polydispersity index, PD, which is defined as Mw of the polymer material over the Mn of the polymer material. In various embodiments, the PD of the high density polyethylene material is between 8 and 10, specifically between 8 and 9, and more specifically between 8.5 and 9. In a specific, embodiment the polydispersity index of the high density polyethylene material is about 8.72 (e.g., 8.72 plus or minus 0.01). It has been found that polyethylene materials having molecular weight characteristics within these ranges provide low moisture vapor transmission characteristics when compared to typical polyethylenes used for containers while still remaining suitable for commercial container production methods (e.g., high volume blow-molding) and providing suitable container properties for commercial use (e.g., strength, rigidity, crack resistance, etc.). In various embodiments, the high density polyethylene has a bi-modal molecular weight distribution profile. In various embodiments, the high density polyethylene material may include any combination of density and/or molecular weight characteristics discussed herein. In a specific embodiment, the high density polyethylene material is the Surpass homopolymer sHDPE film resin, HPs167-AB, available from NOVA Chemicals.

As will be understood to those in the field, the moisture vapor transmission rate of container 10 is also related to the thickness of the walls of container 10 in addition to the material properties of the polymer forming container 10. In various embodiments, the thickness of sidewall 12, shown as T1 in FIG. 2, is between 10 mils and 50 mils and in a specific embodiment is about 40 mils (i.e., 40 mils plus or minus 5 mils) (it should be understood that as used herein a mil is a thousandth of an inch or 0.001 inches). In various embodiments, bottom wall 14 has substantially the same thickness as sidewall 12, and in one embodiment, the thickness of sidewall 12 and bottom wall 14 is substantially constant over the area of container 10. In one embodiment, T1 is between 10 mils and 50 mils with the average thickness at the axial midpoint of sidewall 12 being 40 mils plus or minus 5 mils.

Testing of various polymer materials has been undertaken to determine the moisture vapor transmission rate of container walls using the high density polyethylene resins discussed herein, and the same moisture vapor transmission rate tests were conducted on containers formed from several standard container polyethylene materials for comparison. The containers were formed by blow-molding and were formed from a single material having a monolayer construction as shown in FIG. 2.

Table 1 shows the density and molecular weight characteristics of the four different materials tested, and Table 2 shows the determined moisture vapor transmission rates of blow molded containers formed from each of the four different polyethylene materials. Material A is a moisture barrier, high density polyethylene material having density and molecular weight characteristics as described above, and specifically, material A is Surpass homopolymer sHDPE film resin, HPs167-AB, available from NOVA Chemicals. Materials B-D are polyethylene materials typically used for conventional containers. Specifically, material B is a Hexene HDPE homopolymer having a resin density of 0.963 gr/cc. Material C is a bimodal HDPE having a resin density of 0.956 gr/cc. Material D is a HDPE hexene copolymer having a resin density of 0.953 gr/cc. In various embodiments, materials B and D have unimodal molecular weight distributions.

As demonstrated by the moisture vapor transmission rate data, material A has significantly higher moisture barrier properties (i.e., lower moisture vapor transmission rate) than materials B-D. Further, material A has been found to have characteristics suitable for both commercial scale molding processes and equipment (e.g., blow-molding) and suitable for use in many container applications.

As shown in Table 2, three different moisture vapor transmission rates were calculated for containers formed from materials A-D using three different moisture vapor transmission rate (MVTR) calculation methodologies. These three calculation methods are shown as MVTR 1, MVTR 2 and MVTR 3 in Table 2. The MVTR tests were conducted on ten containers formed from each material, and Table 2 shows the average moisture vapor transmission rates as determined by each of the three MVTR calculation methodologies explained below. The MVTR Tests were conducted utilizing the protocol set forth in USP 31 General Chapter 671 Containers-Performance Testing protocol.

Referring to Table 2, MVTR 1 is a direct measurement of the amount of moisture transmitted through the wall of the container during the test period. MVTR 2 is a MVTR normalized using the calculated wall thickness of the container. For MVTR 2, the surface area of the container, the weight of the container and the measured density of the sidewall of the container were used to calculate the average of the container wall thickness. MVTR 3 is a calculated MVTR normalized based a measured wall thickness measured at the axial mid-point of the container. The unit for MVTR 1 is mg/day-liter of container cavity volume. Thus, MVTR 1 shows the amount of water, in milligrams, per day that will traverse the wall into the container per liter of volume of the container. The unit for both MVTR 2 and MVTR 3 is mg-mil/100 in² per day. Thus, MVTR 2 and MVTR 3 show the amount of water, in milligrams, per day that will traverse a layer of the material having a thickness of 1 mil and surface area of 100 in². As can be seen, MVTR 2 and MVTR 3 are thus normalized providing a MVTR expressed in terms of the thickness of the sidewall.

TABLE 1

| | Material A | Material B | Material C | Material D |
|---|---|---|---|---|
| Mn | 11,595 | 22,087 | 12,604 | 8,759 |
| Mw | 101,072 | 107,297 | 136,846 | 132,801 |
| Mz | 353,889 | 479,727 | 625394 | 982,657 |
| PD (Mw/Mn) | 8.72 | 4.86 | 10.86 | 15.16 |
| Mz/Mn | 30.52 | 21.72 | 49.62 | 112.19 |

TABLE 2

| | | | | MVTR 3 |
|---|---|---|---|---|
| | | | | (gr-mil/ |
| | | | MVTR 2 | day-100 |
| | Density of | MVTR 1 | (gr-mil/ | in²) (per |
| | Container | (mg/day-liter) | day-100 in²) | measured |
| | Wall | (per USP 31 Ch. | (per calculated wall | wall |
| | (gr/cc) | 671) | thickness) | thickness) |
| Mat. A | 0.9488 | 1.145 | 0.0298 | 0.0310 |
| Mat. B | 0.9457 | 2.360 | 0.05410 | 0.0616 |
| Mat. C | 0.9427 | 2.020 | 0.0512 | 0.0566 |
| Mat. D | 0.9389 | 1.840 | 0.0718 | 0.0822 |

In various embodiments, container 10 is formed from a moisture barrier, high density polyethylene material that has a lower moisture vapor transmission rate than many typical container materials such as, materials B-D. In various embodiments, container 10 includes a layer of polyethylene material that has a water vapor transmission rate such that less than 0.050 grams of water per day traverse a layer of the first resin having thickness of 1 mil and a surface area of 100 in² at 100 degrees Fahrenheit and at 100 percent relative humidity. In other embodiments, container 10 includes a layer of polyethylene material that has a water vapor transmission rate such that less than 0.040 grams of water per day traverse a layer of the first resin having thickness of 1 mil and a surface area of 100 in² at 100 degrees Fahrenheit and at 100 percent relative humidity. In these embodiments, the MVTR may be determined either by the methodology of MVTR 2 or MVTR 3 discussed above. Generally, MVTR 2 and MVTR 3 are generally understood as defining a moisture vapor transmission rate that is inversely related to the thickness of the material of the container. Thus, to determine the estimated moisture transmission rate of the materials in Table 2 based on either MVTR 2 or MVTR 3, the MVTR 2 or MVTR 3 shown in Table 2 is divided by the thickness of the container wall in mils. Thus to determine the estimated MVTR of sidewall of container made from materials A-D, MVTR 2 or MVTR 3 is divided by the thickness of the sidewall (e.g., 40 mils, any thickness between 10 mils and 50 mils, etc.) of the container formed from the material.

Referring to FIG. 3 and FIG. 4, container 10 may be formed from more than one layer of material, and the different layers may be configured to provide different properties for container 10 as may be needed for different applications. As shown in the exemplary embodiment of FIG. 3, the walls of container 10 including sidewall 12 may include two layers, a moisture barrier layer, shown as layer 30, and an inner layer 32. In this embodiment, layer 30 is formed from one of the moisture barrier, high density polyethylene materials discussed above regarding the monolayer sidewall embodiment shown in FIG. 2. As discussed above, layer 30 acts as a moisture barrier limiting the movement of moisture into or out of interior cavity 28 of container 10. In the embodiment shown in FIG. 3, layer 30 is the outermost layer of sidewall 12 such that the outer surface of layer 30 defines outer surface 24 of sidewall 12.

Inner layer 32 is in contact with and coupled to the inner surface of layer 30, and in this arrangement the inner surface of inner layer 32 defines the inner surface 26 of sidewall 12 that defines content cavity 28. In various embodiments, inner layer 32 may be formed from an oxygen barrier material. In such embodiments, inner layer 32 acts to limit oxygen passing through the walls of container 10, and outer layer 30 acts as a moisture barrier limiting moisture from passing through the walls of container 10. In various embodiments, inner layer 32 may be formed from one or more oxygen barrier materials used for molded plastic containers. In various embodiments, inner layer 32 is a layer ethylene vinyl alcohol (EVOH), and in another embodiment, inner layer 32 is a layer of Nylon. In various embodiments, one or more layer of adhesive material may be located between inner layer 32 and outer layer 30 to couple layers 30 and 32 together.

In other embodiments, layer 32 may also be formed from a polyethylene material. In various embodiments, layer 32 may be formed from a polyethylene material having a resin density of between 0.953 and 0.965 grams/cc. In various embodiments, layer 32 may be formed from polyethylene materials B-D discussed above.

As shown in the exemplary embodiment of FIG. 4, the walls of container 10 may include more than two layers configured to provide different properties for container 10 as may be needed for different applications. As shown in FIG. 4, the walls of container 10 including sidewall 12 may include a third layer, shown as outer layer 34. As shown, outer layer 34 is coupled to the outer surface of layer 30, and in this arrangement, the outer surface of outer layer 34 defines outer surface 24 of sidewall 12. In various embodiments, layer 34 is formed one or more oxygen barrier materials used for molded plastic containers. In various embodiments, outer layer 34 a layer ethylene vinyl alcohol, and in another embodiment, outer layer 34 is a layer of Nylon. In this embodiment, layer 34 acts to limit oxygen from passing through sidewall 12 and into contents cavity 28.

In other embodiments, layer 34 may also be formed from a polyethylene material. In various embodiments, layer 34 may be formed from a polyethylene material having a resin density of between 0.953 and 0.965 grams/cc. In various embodiments, layer 34 may be formed from polyethylene materials B-D discussed above.

In embodiments such as shown in FIG. 4 in which the oxygen barrier material defines the outer surface of sidewall 12, inner layer 32 may be configured to protect sidewall 12 from interaction or absorption of material held within container 10. In such embodiments, inner layer 34 is a layer ethylene vinyl alcohol, and in another embodiment, inner layer 34 is a layer of Nylon. In other embodiments, inner layer 34 may be a fluorinated inner layer of the material of layer 30. In other embodiments, layer 30 may be formed from one of the moisture barrier, high density polyethylene materials discuss above, and either layer 32 and/or 34 is formed from a layer of a different polyethylene material. In such embodiments, either layer 32 and/34 may be formed from materials B-D discussed above, and layer 30 may be formed from material A discussed above.

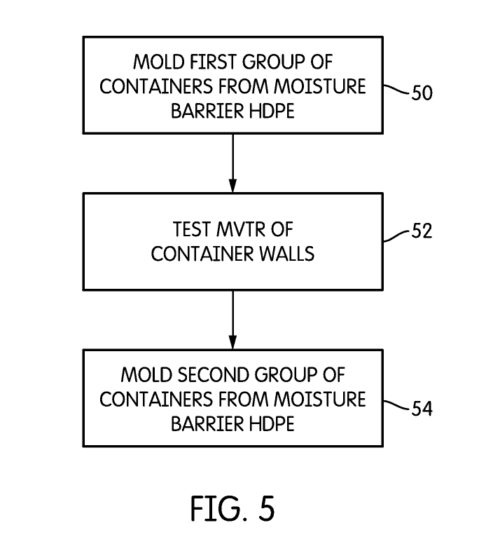

Referring to FIG. 5, a method of forming low moisture vapor transmission plastic containers is shown according to an exemplary embodiment. At step 50, a first group of containers is molded from one of the moisture barrier, high density polyethylene (HDPE) materials discussed above, and in a specific embodiment, the HDPE is material A discussed above. At step 52, the moisture vapor transmission rates (MVTR) of the walls of the containers of the first group are tested. In various embodiments, the MVTR tests of the method of FIG. 5 are conducted utilizing the protocol set forth in USP General Chapter 671 Containers-Performance Testing protocol. In at least one embodiment, the container has a water vapor transmission rate such that less than 0.050 grams of water per day traverse a layer of the first resin having thickness of 1 mil and a surface area of 100 in² at 100 degrees Fahrenheit and 100 percent relative humidity. At step 54, a second group of containers of containers is molded from the moisture barrier HDPE materials. In various embodiments, the resin density of the moisture barrier HDPE material is greater than 0.960 and less than 0.970 grams/cc. In some such embodiments, the first and second groups of containers are formed by a blow molding method and the density of the moisture barrier HDPE material is between 0.945 and 0.95 grams/cc. In various embodiments, the containers formed by the method of FIG. 5, may be any of the embodiments of container 10 discussed above.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. Other substitutions, modifications, changes and omissions may also be made in the design, operating conditions and arrangement of the various exemplary embodiments without departing from the scope of the present invention.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above in the implementation of the teachings of the present disclosure.

What is claimed is:

1. A molded, low moisture vapor transmission plastic container comprising:
a sidewall including an inner surface, an outer surface, a thickness and a first layer formed from a high density polyethylene resin;
a bottom wall located at a lower end of the sidewall, the bottom wall including an inner surface and an outer surface, wherein the inner surfaces of the sidewall and of the bottom wall define an interior contents cavity; and
a neck located at an upper end of the sidewall defining an opening into the interior contents cavity;
wherein the high density polyethylene resin of the first layer has a resin density of about 0.966 grams/cc and a polydispersity index of about 8.72, wherein the first layer has a USP 31 Chapter 671 moisture vapor transmission rate of 1.145 mg/day-liter or less.

2. The molded, low moisture vapor transmission plastic container of claim 1, wherein the high density polyethylene resin of the first layer is an octene homopolymer.

3. The molded, low moisture vapor transmission plastic container of claim 1, wherein the container is blow-molded, wherein the sidewall has a thickness of about 40 mils, and further wherein the density of the first layer following blow-molding is about 0.949 grams/cc.

4. The molded, low moisture vapor transmission plastic container of claim 1, wherein the sidewall includes a second layer of polymer material adjacent to the first layer.

5. The molded, low moisture vapor transmission plastic container of claim 4, wherein the second layer of the sidewall is an EVOH layer.

6. The molded, low moisture vapor transmission plastic container of claim 4, wherein the second layer of the sidewall is formed from a high density polyethylene layer having a resin density of between 0.953 and 0.965 grams/cc.

7. The molded, low moisture vapor transmission plastic container of claim 1, further comprising a closure, wherein the neck includes an engagement structure, wherein the closure is coupled to the neck by the engagement structure.

8. The molded, low moisture vapor transmission plastic container of claim 7, wherein the engagement structure is threading.

9. The molded, low moisture vapor transmission plastic container of claim 7, further comprising a pharmaceutical product located within the interior contents cavity of the container.

10. A low moisture vapor transmission plastic container comprising:
a sidewall including an inner surface, an outer surface and a thickness;
a bottom wall located at a lower end of the sidewall, the bottom wall including an inner surface and an outer surface, wherein the inner surfaces of the sidewall and the bottom wall define an interior contents cavity; and
a neck located at an upper end of the sidewall and including an engagement structure configured to engage a closure to seal the container;
wherein at least a portion of the sidewall is formed from a moisture barrier, high density polyethylene resin having a resin density greater than 0.960 and less than 0.970 grams/cc and a polydispersity index between 8 and 10, wherein the sidewall has a thickness between 10 mil and 50 mils, wherein the moisture barrier, high density polyethylene resin has a water vapor transmission rate such that less than 0.050 grams of water per day traverse a layer of the moisture barrier, high density polyethylene resin having thickness of 1 mil and a surface area of 100 in².

11. The low moisture vapor transmission plastic container of claim 10, wherein the moisture barrier, high density polyethylene resin is an octene homopolymer.

12. The low moisture vapor transmission plastic container of claim 11, wherein the container is blow-molded, and the density of moisture barrier, high density polyethylene resin of the sidewall following blow-molding is between 0.945 and 0.95 grams/cc.

13. The low moisture vapor transmission plastic container of claim 10, wherein the sidewall includes at least two layers of polymer material.

14. The low moisture vapor transmission plastic container of claim 13, wherein at least one layer of the sidewall is an EVOH layer.

15. The low moisture vapor transmission plastic container of claim 13, the sidewall has a thickness of about 40 mils.

16. The low moisture vapor transmission plastic container of claim 13, wherein the moisture barrier, high density polyethylene resin has a water vapor transmission rate such that less than 0.040 grams of water per day traverse a layer of the moisture barrier, high density polyethylene resin having thickness of 1 mil and a surface area of 100 in².

17. A method of forming low moisture vapor transmission plastic containers comprising:
molding a first group of a plurality of container from a polyethylene resin having a resin density greater than 0.960 and less than 0.970 grams/cc and a polydispersity index between 8.5 and 9.0;
testing the moisture vapor transmission rate of a wall of each container of the first group, wherein the container formed from the polyethylene resin has a water vapor transmission rate such that less than 0.050 grams of water per day traverse a layer of the polyethylene resin having thickness of 1 mil and a surface area of 100 in²; and
molding a second group of a plurality of containers, each container of the second group having a layer formed from the polyethylene resin and having a sidewall defining an interior cavity and a neck defining an opening into the interior cavity.

18. The method of claim 17, wherein the first group of containers and the second group of containers are formed by blow-molding, and the density the polyethylene resin following blow-molding is between 0.945 and 0.95 grams/cc.

19. The method of claim 18, wherein the polyethylene resin is an octene homopolymer.

20. The method of claim 18, wherein a sidewall of the containers of the second group of containers has a thickness between 10 mil and 50 mil.
